(19) United States
(12) Patent Application Publication
(10) Pub. No.: US 2013/0288153 A1
(43) Pub. Date: Oct. 31, 2013

(54) Sodium-Sulfur Battery

(71) Applicant: MORIS TECHNOLOGY CENTER LLC, Hillsborough, NJ (US)

(72) Inventor: Fangxiao YANG, Hillsborough, NJ (US)

(73) Assignee: Moris Technology Center LLC, Hillsborough, NJ (US)

(21) Appl. No.: 13/865,767

(22) Filed: Apr. 18, 2013

Related U.S. Application Data
(60) Provisional application No. 61/640,190, filed on Apr. 30, 2012.

(51) Int. Cl. H01M 8/10; H01M 8/18; H01M 8/20

(52) U.S. Cl. CPC H01M 8/1004; H01M 8/20; H01M 8/188
USPC 429/482

(57) ABSTRACT

A sodium sulfur secondary battery is a battery that operates at a comparatively lower temperature, while maintaining a high operating cell potential comparable to existing sodium sulfur battery configurations. The apparatus accomplishes this through the arrangement of component materials selected based on experimentation results demonstrating favorable performance in a secondary battery configuration. The sodium sulfur battery comprises a housing, containing an anode solution, a cathode solution, and a sodium ion conductive electrolyte membrane. The anode solution contains metallic sodium and anode solvent. The cathode solution contains elemental sulfur and a cathode solvent. The sodium ion conductive electrolyte membrane is a Sodium Titanate Nano-membrane formed from long TiO2-nanowires. The electrolyte membrane is positioned between the anode solution and the cathode solution. The electrolyte membrane is able to selectively transports of sodium ion between the anode solution and the cathode solution at temperatures below 75° C. generating an electrode potential.

The current application claims a priority to the U.S. Provisional Patent application Ser. No. 61/640,190 filed on Apr. 30, 2012.

### FIELD OF THE INVENTION

The present invention relates generally to an electrochemical battery and more specifically to a sodium-sulfur secondary battery that functions at temperatures below 75° C.

### BACKGROUND OF THE INVENTION

A battery is a device used to store and release electricity for various applications. This store and release process involves a chemical energy to electrical energy conversion or vice versa. Batteries broadly fit into three main application classes. Stationary batteries are for backup power and load leveling. Mobile batteries are for portable electronic devices such as mobile phones and laptops. Transport batteries are for the electric propulsion of vehicles.

In a stationary application, the battery weight is less important and the main objective is to store as much electricity as possible for the money. This does not just mean the initial cost of the battery but also how long it lasts, both in terms of years and the number of charge/discharge cycles it can provide before its performance deteriorates below an acceptable level. Where the battery is regularly charged and discharged (e.g. for storing solar power), it is also important for the battery to be electrically efficient. Structurally though, the constraints are few. As long as the battery does not leak and can support its own weight, it will suffice.

In a mobile application, price is only of moderate importance and the key parameters are energy density and power density. The number of cycles is important as mobile devices are frequently charged daily although lifespan requirements are moderate as most mobile devices have lamentably short lifespan themselves! Electrical efficiency is not really a consideration here as the devices being powered are generally modest consumers of power. Mobile batteries must be rugged in their construction and in particular, they must not leak. Transport applications are far more demanding, combining the needs of both the stationary and the mobile batteries Like mobile, the key parameters are energy density and power density as these provide range and performance. And like stationary, the number of cycles, overall lifespan and electrical efficiency, are all of major importance, as is the price. The batteries must be as rugged and not spill their contents even in high speed accidents.

Fundamentally, all batteries provide electricity by means of a chemical reaction. In all chemical reactions, one material has a greater affinity for electrons than another but only in some reactions can the difference in electron affinity be exploited to create an electric current. Some chemical reactions that can be exploited in this way are reversible by electrolysis while others are not which is why only some types of batteries are rechargeable. Structurally, a battery cell will have a minimum of three entities: two electrodes (anode and cathode) and an electrolyte separating the two. All three entities will consist of different materials and at least two entities, either the two electrodes or one electrode and the electrolyte, will participate in the chemical reaction.

Broadly the energy density (by weight) of any given battery type, is down to which materials are used as reactants. The difference between the reactants in electron affinity affects the voltage of the cells. Some reactions exchange one electron, others exchange two and some rarer reaction such as those involving aluminum exchange three. The available energy from the reaction is related to the product of the voltage and the number of electrons exchanged while the energy density will be directly affected by the ratio of this product to the combined atomic weight of the reactants. The other battery parameters are affected by the physical construction of the battery and this again is largely dictated by the chemistry.

Generally, a single battery includes one or more galvanic cells, wherein each of the cells is made of two half-cells that are electrically isolated except through an external circuit. During discharge, electrochemical reduction occurs at the cell's positive electrode, while electrochemical oxidation occurs at the cell's negative electrode. While the positive electrode and the negative electrode in the cell do not physically touch each other, they are generally chemically connected by one or more ionically conductive and electrically insulative electrolytes, which can be in either a solid state, a liquid state, or in a combination thereof. When an external circuit, or a load, is connected to a terminal that is connected to the negative electrode and to a terminal that is connected to the positive electrode, the battery drives electrons through the external circuit, while ions migrate through the electrolyte.

The primary electrolyte separators used in sodium batteries are typically a high ion conduct efficiency membrane which is made from ion conductive polymers, porous materials infiltrated with ion conductive liquids or gels, or dense ceramics. In this regard, most, if not all, rechargeable sodium batteries that are presently available for commercial applications comprise a molten sodium metal negative electrode, a sodium β-alumina ceramic electrolyte separator, and a molten positive electrode, which may include a composite of molten sulfur and carbon (called a sodium/sulfur cell), or molten NiCl₂, NaCl, FeCl₂, and/or NaAlCl₄ (called a ZEBRA cell).

The sodium sulfur battery can have very high energy and power densities because of the chemistries of alkali metals of which sodium is a member. Reported figures differ widely, mostly because of differences in the construction of working systems. Mostly this is down to different approaches to insulation but also to such factors as thickness of electrolyte and cell walls. The lowest energy densities are around 50 Wh/Kg and the highest are around 200 Wh/Kg. Power densities range from about 100 W/Kg to 200 W/Kg. During discharge, electrons are striped from the sodium atoms and flow from the sodium anode through the external load to the sulfur cathode. The positively charged sodium ions move through the electrolyte where they react with the sulfur and the electrons to produce sodium polysulfide. During recharge, the applied voltage strips electrons from the sodium polysulfide turning it back into sulfur and sodium ions. The sodium ions now cross the electrolyte into the sodium where they are reunited with their missing electrons to form sodium atoms.

The sodium-sulfur battery constructed with β-alumina ceramic electrolyte separator actually has a very high electrical efficiency of the order of 85% but the electrical efficiency of sodium sulfur batteries as a whole are normally quoted as being around 75%. This lower figure is actually an inappropriate use of averages. In the electrical sense the efficiency is 85% comprising a columbic efficiency of virtually 100% and a charge/discharge voltage ratio of 0.85 or better. The battery also has a very low self-discharge rate. Both the high columbic efficiency and low self-discharge are due to beta alumina being an extremely poor conductor of electrons. For the exactly the same reason, very high operating temperature (e.g. 300 to 400° C.) is typically required and this high operation temperature introduces a different form of energy inefficiency and self-discharge. More specifically, a battery operating at this level of temperature is subject to significant thermal management problems and thermal sealing issues. For example, some sodium-based rechargeable batteries may have difficulty dissipating heat from the batteries or maintaining the negative electrode and the positive electrode at the relatively high operating temperatures. This is an issue because the battery must be at its operating temperature in order to deliver or accept current and unless the user is prepared for very long startup times, the temperature must be permanently maintained. Regardless of how good the insulation is, this requires energy and is thus a form of self-discharge.

Furthermore, the relatively high operating temperatures of some sodium-based batteries can create significant safety issues as well as material lifetime reduction. The relatively high operating temperatures of some sodium-based batteries also require battery components to be resistant to, and operable at, such high temperatures. Accordingly, such components can be relatively expensive. It is no doubt that a sodium-based battery operating at low temperature such as below the melting point of sodium can offer many benefits, however, new technical challenges are encountered. For example, batteries that use molten sodium often have the liquid metal negative electrode in direct contact with the ceramic electrolyte separator.

### BRIEF SUMMARY OF THE INVENTION

The present invention has been developed to provide a sodium sulfur secondary that operates at a comparatively lower temperature, while maintaining a high operating cell potential comparable to existing sodium sulfur battery configurations. The present invention is a sodium sulfur battery that operates as a galvanic cell when charging and as an electrolytic cell when being discharged. The sodium sulfur battery of the present invention comprises a housing, a sodium ion conductive electrolyte membrane, an anode solution, a cathode solution, a negative terminal, and a positive terminal. The housing is provided as the enclosure that contains the anode solution, the cathode solution, and the sodium ion conductive electrolyte membrane. The housing includes an anode compartment, a cathode compartment and a separator mount. The sodium ion conductive electrolyte membrane is securely attached to the separator mount forming a division within the housing that physically separates the anode compartment from the cathode compartment. The anode compartment is the interior portion of the housing that contains the anode solution. Similarly, the cathode compartment is the interior portion of the housing that contains the cathode solution. The anode solution is the negative electrode that is a liquid at room temperature and comprises at least one anode solvent and metallic sodium. The cathode solution is the positive electrode that is a liquid at room temperature and comprises at least one cathode solvent and the elemental sulfur. The negative terminal is the current collector that traverses the housing into the anode compartment. The positive terminal is the current collector that traverses the housing into the cathode compartment.

The anode solution is found positioned within the anode compartment and comprises metallic sodium and at least one anode solvent when the sodium sulfur battery is at least partially charged. It should be understand by those of skill in the art, however, that in an uncharged or fully discharged state, the anode solution may not contain any metallic sodium. Generally, the anode solution contains an amount of metallic sodium that remains in solid state and throughout the stages of sodium sulfur battery's operation. The at least one anode solvent is provided with properties that enables it to suspend the metallic sodium while having certain solubility to the metallic sodium at room temperature. The at least one anode solvent functions as the transportation vehicle for the dissolved metallic sodium and the sodium ions in order to interact with the surface of the sodium ion conductive electrolyte membrane, which is the physical barrier dividing the anode solution in the anode compartment to the cathode solution in the cathode compartment. It should be noted that the metallic sodium can be provided in particles, flakes, or blocks that are suspended in the at least one anode solvent. In this regard, the metallic sodium may be a pure sample of sodium, an impure sample of sodium, and/or a sodium alloy.

The at least one anode solvent can be provided by any non-aqueous electrolyte solution that is able to function as a transportation vehicle for sodium ions while remaining in a liquid state at the sodium sulfur battery's operating temperature range (i.e. 20 to 100° C.). The at least one anode solvent is provided with a higher density relative to the metallic sodium at room temperature enabling the metallic sodium to be suspended within the anode solvent. The at least one anode solvent is chemically compatible with the materials of the negative terminal and the sodium ion conductive electrolyte membrane. The at least one anode solvent can be an organic electrolytes or an ionic liquids as long as the aforementioned characteristics are met. It should be noted that because certain ionic liquids have a higher ionic conductivity than the sodium ion conductive electrolyte membrane and/or because some ionic liquids can act as a surfactant, ionic liquids are preferred the at least one anode solvent.

The cathode solution is found positioned within the cathode compartment and comprises elemental sulfur and at least one cathode solvent when the battery is at least partially discharged. It should be understood by those of skill in the art, that in a discharged state, that the cathode solution may additionally contain sodium ions as well as sodium polysulfide. Furthermore, it should be noted that in the at least partially charged state, solid elemental sulfur should be present due to the sodium sulfur battery's low operating temperature. The at least one cathode solution is provided with properties that enables it to suspend the elemental sulfur while having certain solubility to the elemental sulfur and to sodium ions at room temperature. The at least one cathode solvent functions as the transportation vehicle for the dissolved elemental sulfur, the sodium ions, and the sodium polysulfide in order to interact with surface of the sodium ion conductive electrolyte membrane, which is the physical barrier dividing the anode solution in the cathode compartment to the cathode solution in the cathode compartment. The at least one anode solvent can be provided as any suitable material that is capable of conducting sodium ions to and from the electrolyte membrane separator and that otherwise allows the cell to function as intended.

The sodium ion conductive electrolyte membrane separates the anode solution in the anode compartment from the cathode solution in the cathode compartment. The sodium ion conductive electrolyte membrane can be provided as any membrane that selectively transports sodium ions but inhibits the transport of metallic sodium, at the battery's operating temperature. The sodium ion conductive electrolyte membrane is non-electrically conductive and stable when in contact with the anode solution and the cathode solution. The sodium ion conductive electrolyte membrane can be a Sodium Super Ion Conductive (NaSICON) membrane or another type of fast ion conductive nano-membrane composite that is substantially impermeable to water. Preferably, the separator is an inorganic nano-fiber membrane which can be assembled into a free standing membrane.

The negative terminal is a current collector associated with the anode compartment. The negative terminal traverses the housing into the anode compartment and is partially immersed in the anode solution. The negative terminal is provided to be in electrical contact with the anode solution. The negative terminal is constructed of a highly electrically conductive material that does not react with dissolved sodium ions or the at least one anode solvent.

The positive terminal is the current collector associated with the cathode compartment. The positive terminal traverses the housing into the cathode compartment and is partially immersed in the cathode solution. The positive terminal is provided to be in electrical contact with the cathode solution. The positive terminal is constructed from a tough corrosion resistant material that is able to resist corrosion from sulfur and sodium polysulfide.

### Battery Charging:

The oxidation reaction that occurs in the cathode compartment,
Na₂Sₓ→xS+2Na⁺+e⁻

The reduction reaction that occurs in the anode compartment,
Na⁺+e⁻→Na

During the charging cycle, the sodium sulfur battery functions as an electrolytic cell converting electrical energy into chemical energy. the sodium sulfur battery accomplishes this through the selective transport of sodium ions from the cathode solution across the sodium ion conductive electrolyte membrane to the anode solution. The voltage stored in electrical potential energy for the sodium sulfur battery is calculated at being 2.15 to 2.35 Volts.

### Battery Discharging:

Oxidation reaction taking place in the anode compartment.

Na→Na⁺+e⁻

Reduction reaction taking place in the cathode compartment.

2Na⁺+xS+e⁻Na₂Sₓ

During the discharge cycle, the sodium sulfur battery functions as a galvanic cell converting chemical energy into electrical energy. The sodium sulfur battery accomplishes this through the selective transport of sodium ion from the anode solution across the sodium ion conductive electrolyte membrane to the cathode solution. The voltage generated by the change in electric potential is calculated at being 2.15 to 2.35 Volts. Both the charging cycle and the discharging cycle of the sodium sulfur battery occur at suitable operating temperature that allows both the metallic sodium and the elemental sulfur to remain in a solid state. Suitable operating temperature ranges that can be provided for the sodium sulfur battery are provided as being between 10° C. to about 100° C.

### BRIEF DESCRIPTIONS OF THE DRAWINGS

FIG. 1 is a cross sectional view of the sodium sulfur battery displaying component arrangements of the housing, the anode compartment, the cathode compartment, the negative terminal, the positive terminal, and the sodium ion conductive electrolyte membrane, as per the current embodiment of the present invention.

FIG. 2 is a block diagram displaying the components contained within the anode compartment, as per the current embodiment of the present invention.

FIG. 3 is a block diagram displaying the components contained within the cathode compartment, as per the current embodiment of the present invention.

FIG. 4 is a cross sectional view of the sodium sulfur battery displaying the sodium ion movement across the sodium ion conductive electrolyte membrane during the discharge cycle, as per the current embodiment of the present invention.

FIG. 5 is a cross sectional view of the sodium sulfur battery displaying the sodium ion movement across the sodium ion conductive electrolyte membrane during the charge cycle, as per the current embodiment of the present invention.

FIG. 6 is a graph displaying the results of voltage cycling tests conducted on preferred embodiment of the present invention, wherein each pulse represents a completed charge and discharge cycle.

FIG. 7 is a table displaying the viscosity and the chemical structure of the ionic liquids associated with at least one anode solvent group, as per the current embodiment of the present invention.

FIG. 8 is a table displaying the viscosity and the chemical structure of the polar solvents associated with at least one cathode solvent group, as per the current embodiment of the present invention.

FIG. 9 is a photograph taken with a scanning electron microscope (SEM) displaying a cross sectional view of the Sodium Titanate Nano-membrane showing the multi-decker texture, and with a photograph taken with a transmission electron microscope demonstrating the average diameter of single nanowire about 50-60 nm, positioned in the upper left hand corner.

FIG. 10 is a low resolution photograph taken with a displaying scanning electron microscope (SEM) many intertwined nanowires, of the Sodium Titanate Nano-membrane, that are typically longer than 0.1 mm, and with a high-resolution photograph taken with a scanning electron microscope (SEM) depicting the macropores of scaffolding nanowires, positioned in the upper left hand corner.

### DETAIL DESCRIPTIONS OF THE INVENTION

All illustrations of the drawings are for the purpose of describing selected versions of the present invention and are not intended to limit the scope of the present invention.

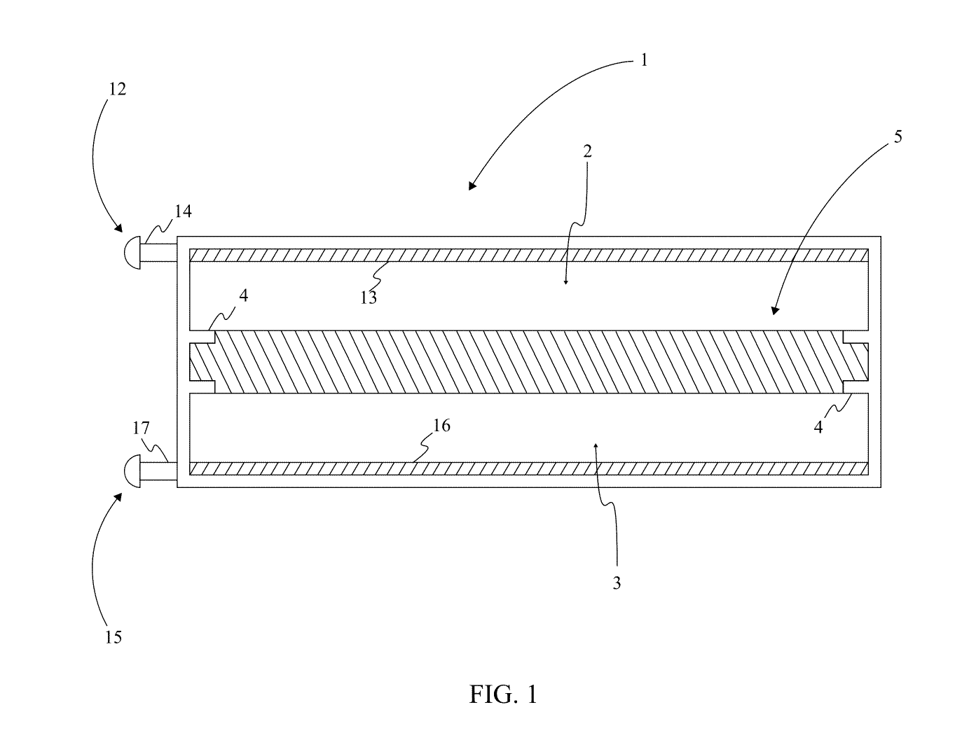

Referencing FIG. 1, the present invention provides a sodium sulfur battery that operates at temperatures below 100° C. In the current embodiment of the present invention the sodium sulfur battery comprises a housing 1, a sodium ion conductive electrolyte membrane 5, an anode solution 6, a cathode solution 8, a negative terminal 12, and a positive terminal 15. The housing 1 functions as the enclosure that contains the sodium ion conductive electrolyte membrane 5, the anode solution 6, and the cathode solution 8. The sodium ion conductive electrolyte membrane 5 functions as an electrolyte separator that selectively transports sodium ions between the anode solution 6 and the cathode solution 8. The anode solution 6 is the anionic electrolyte and the cathode solution 8 is the cathodic electrolyte. The negative terminal 12 and the positive terminal 15 are the electrodes that correspond to the anode solution 6 and the cathode solution 8, respectively.

The housing 1 is the enclosure that contains the anode solution 6, the cathode solution 8, and the sodium ion conductive electrolyte membrane 5. The anode solution 6, the cathode solution 8, and the sodium ion conductive electrolyte membrane 5 are securely sealed within the housing 1. The housing 1 is constructed of an inert material that is resistant to corrosion. In the current embodiment of the present invention, the housing 1 comprises an anode compartment 2, a cathode compartment 3, and a separator mount 4. The separator mount 4 is provided as the means of securing the sodium ion conductive electrolyte membrane 5 to the housing 1. The secured sodium ion conductive electrolyte membrane 5 partitions the housing 1 forming the anode compartment 2 and the cathode compartment 3. The secured sodium ion conductive electrolyte membrane 5 is positioned between the anode compartment 2 and the cathode compartment 3. The anode compartment 2 is the interior portion of the housing 1 that contains the anode solution 6. The anode compartment 2 is traversed into by the negative terminal 12. The cathode compartment 3 is the interior portion of the housing 1 that contains the cathode solution 8. The cathode compartment 3 is traversed into by the positive terminal 15. The sodium ion electrolyte membrane 5 selectively separates the contents of the anode compartment 2 from the contents of the anode compartment 2.

Referencing FIG. 1, in the current embodiment of the present invention, the separator mount 4 is positioned between the anode compartment 2 and the cathode compartment 3. The separator mount 4 is provided as the means of securing the sodium ion conductive electrolyte membrane 5 within the housing 1. The separator mount 4 can engage the sodium ion conductive electrolyte membrane 5 through a plurality of means that securely separates the anode compartment 2 from the cathode compartment 3. The separator mount 4 but can utilize any attachment means that permits direct contact between the sodium ion conductive electrolyte membrane 5 with the anode solution 6 and the cathode solution 8. Furthermore, the attachment means utilized by the separator mount 4 must have negligible chemical and electrical interactions with the anode solution 6 and the cathode solution 8. The separator mount 4 can utilize a plurality of secure attachment means for engaging the sodium ion conductive electrolyte membrane 5. These attachment means can includes, but is not limited to fasteners and adhesives, as well as any combination thereof.

In the current embodiment of the present invention, the sodium ion conductive electrolyte membrane 5 is the ion separator that is positioned within the housing 1. The sodium ion conductive electrolyte membrane 5 is secured within the housing 1 by way of the separator mount 4. The sodium ion conductive electrolyte membrane 5 is positioned between the anode compartment 2 and the cathode compartment 3. The sodium ion conductive electrolyte membrane 5 is in fluid contact with both the anode solution 6 and the cathode solution 8. The sodium ion conductive electrolyte membrane 5 selectively separates the anode solution 6 and the cathode solution 8 allowing the selective transport of sodium ion between the anode solution 6 and the cathode solution 8 at temperatures below 75° C.

TABLE 1
Sodium Titanate Nano-Membrane Ionic Conductivity

| | Ionic Conductivity |
|---|---|
| Temperature (° C.) | milli-Siemens/centimeter (mS/cm) |
| 25° C. | 0.8 mS/cm |
| 60° C. | 1.2 mS/cm |
| 75° C. | 3.2 mS/cm |

In the preferred embodiment of the present invention, the sodium ion conductive electrolyte membrane 5 is a Sodium Titanate Nano-Membrane capable of selectively transporting sodium ions between the anode solution 6 and the cathode solution 8. The Sodium Titanate Nano-Membrane is able to effectively transport sodium ions between the anode solution 6 and the cathode solution 8 with a calculated ionic conductivity for sodium ions at 0.8 milli-Siemens/centimeters (mS/cm) at 25° C. The Sodium Titanate Nano-Membrane accomplishes this through a unique construction that is sensitive to the size and charge of sodium ions. The sodium titanate nano-membrane's unique construction prevents the passage of metallic sodium 8, elemental sulfur 11, sulfur ions, and water between the anode solution 6 and the cathode solution 8. The sodium titanate nano-membrane is constructed from TiO₂-nanowires that are casted into a thermalstable and multifunctional free standing membrane (FSM).

The negative terminal 12 is the current collector that is in electrical contact with the anode solution 6. The negative terminal 12 traverses the housing 1 into the anode compartment 2. The negative terminal 12 is in electrical contact with the anode solution 6 due to the positioning of the negative terminal 12 within the anode compartment 2. The negative terminal 12 is able to maintain an electrical contact with the anode solution 6 due to being at least partially immersed in the anode solution 6. The negative terminal 12 is constructed of a highly electrically conductive material that does not react with dissolved sodium ions or the at least one anode solvent 7. In the current embodiment of the present invention, the negative terminal 12 comprises a first end and a second end. The first end of the negative terminal 13 is the portion of the negative terminal 12 that traverse into the anode compartment 2 and is found at least partially immersed in the anode solution 6. The second end of the negative terminal 14 is positioned peripherally to the housing 1 and functions as an attachment point for electrical leads associated with the negative terminal 12. In the preferred embodiment of the present invention the negative terminal 12 is constructed of copper. Copper is selected as the material for the negative terminal 12 due to its high electrical conductivity and its relatively low reactivity with dissolved metallic sodium 8, the at least one anode solvent 7, and sodium ions.

The positive terminal 15 is the current collect that is contact with the cathode solution 8. The positive terminal 15 traverses the housing 1 into the cathode compartment 3. The positive terminal 15 is in electrical contacts with the cathode solution 8 due to the positioning of positive terminal 15 within the cathode compartment 3. The positive terminal 15 is able to maintain an electrical contact with the cathode solution 8 due to being at least partially immersed in the cathode solution 8. The positive terminal 15 is constructed of a tough corrosion resistant material that does not react with dissolved sulfur, polysulfides, and sodium polysulfides. In the current embodiment of the present invention, the positive terminal 15 comprises a first end and a second end. The first end of the positive terminal 16 is the portion of the positive terminal 15 that traverse into the cathode compartment 3 and is found at least partially immersed in the cathode solution 8. The second end of the positive terminal 17 is positioned peripherally to the housing 1 and functions as an attachment point for the electrical leads associated with the positive terminal 15. In the preferred embodiment of the present invention the positive terminal 15 is constructed of graphite. Graphite is selected as the material for the positive terminal 15 due to its corrosion resistance in the presence of sulfur ion.

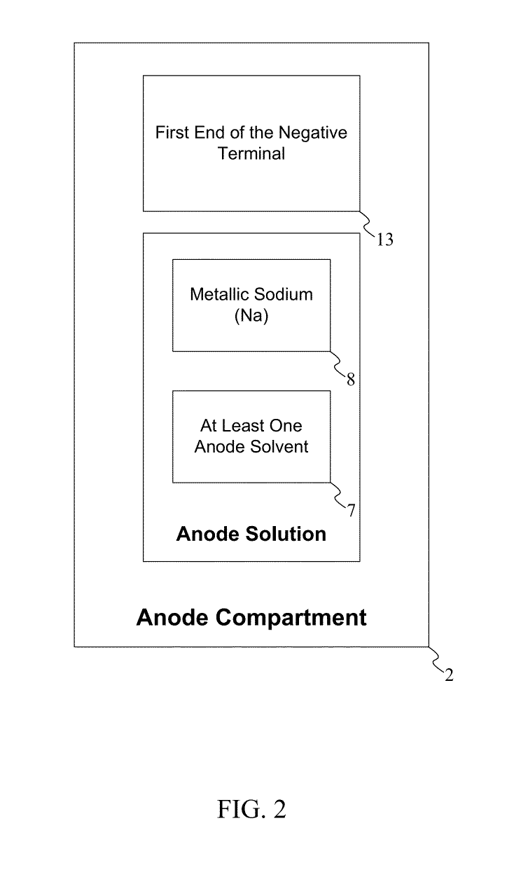

Referencing FIG. 2, the anode solution 6 is an electrolyte that functions as an negative electrode for the present invention. The anode solution 6 is found positioned within the anode compartment 2 of the housing 1. The anode solution 6 is separated from the cathode solution 8 by the sodium ion conductive electrolyte membrane 5. The anode solution 6 is in electrical contact with the negative terminal 12 due to the positioning of the negative terminal 12 within the anode compartment 2. The negative terminal 12 is able to maintain an electrical contact with the anode solution 6 due to it being at least partially immersed in the anode solution 6. In the current embodiment of the present invention, the anode solution 6 comprises at least one anode solvent 7 and metallic sodium 8. the at least one anode solvent 7 is provided as an ionic liquid that has certain solubility to metallic sodium 8 at temperatures below metallic sodium 8's melting point, wherein metallic sodium 8's melting point is 97.72° C. The metallic sodium 8 is provided as the anode for the sodium sulfur battery. the metallic sodium 8 is suspended within the at least one anode solvent 7 due to the at least one anode solvent 7 being heavier than the metallic sodium 8, wherein the metallic sodium 8 has a density of metallic sodium 8 is 0.968 g/cm³ at 25° C. The at least one anode solvent 7 functions as the transport medium that facilitates the interaction between sodium ions and the surface of the sodium ion conductive electrolyte membrane 5. The metallic sodium 8 is provided as the initial source of sodium ions within the sodium sulfur battery. During the discharge cycle of the sodium sulfur battery, the metallic sodium 8 functions as the electron donor that is oxidized forming sodium ions (Na⁺). During the charging cycle of the sodium sulfur battery, the metallic sodium 8 is the reduction product. In the current embodiment of the present invention, the metallic sodium 8 is provided with a mass concentration up to 900 g/L to the at least one anode solution 6. The mass concentration of the anode solution 6 was determined based on experimentation results which demonstrated favorable performance in the Sodium Sulfur battery. It should be noted that the presence of metallic sodium 8 in the anode solution 6 can depend on the electrode potential of the battery, wherein the metallic sodium 8 is present when the sodium sulfur battery is at least partially charged and be completely absent when the sodium sulfur battery is completely discharged.

TABLE 2
Summary of Anode Solvents

| | Molecular | CAS Registry | Density |
|---|---|---|---|
| Solvent | Weight (Mw) | Number | (g/cm) |
| 1-Ethyl-3-methylimidazolium | 170.21 | 143314-17-4 | 1.027 |
| acetate, [EMIM][Ac] | | | |
| 1-Butyl-3-methylimidazolium | 198.26 | 284049-75-8 | 1.055 |
| acetate, [BMIM][Ac] | | | |
| 1-Butyl-3-methylimidazolium | 419.36 | 174899-83-3 | 1.440 |
| bis(trifluoromethylsulfonyl)imide, | | | |
| [BMIM][Tf₃N] | | | |
| 50% [EMIM][Ac] | | | 1.234 |
| 50% [BMIM][Tf₃N] | | | |

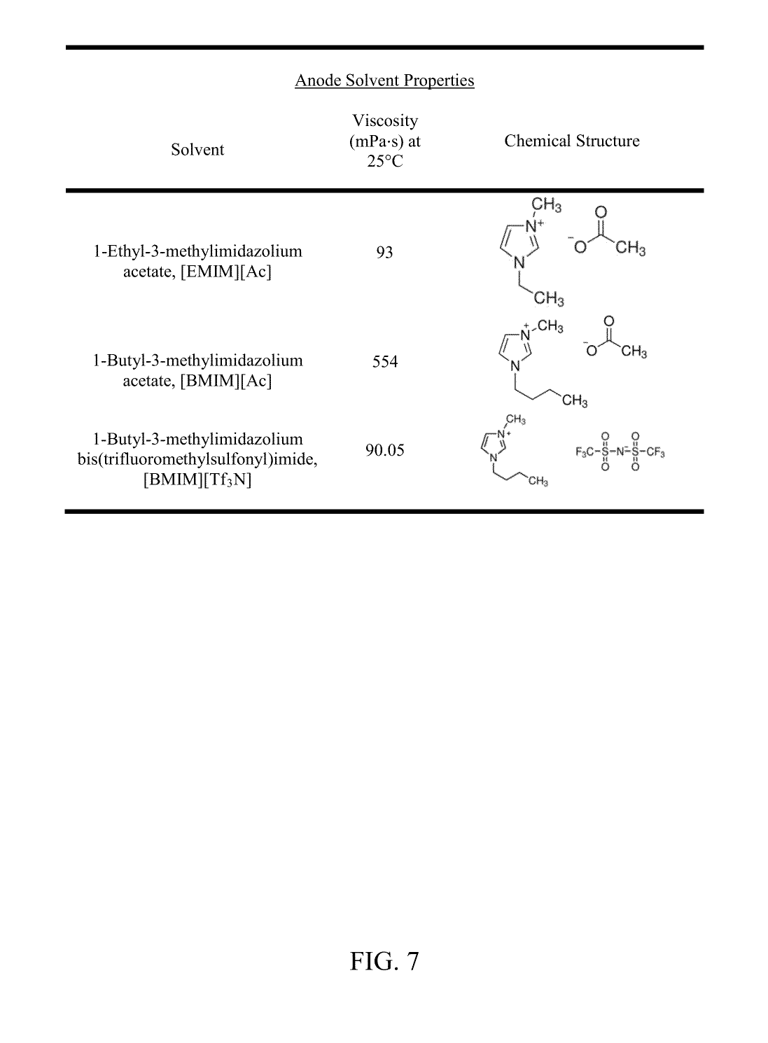

Referencing FIG. 7, in the current embodiment of the present invention the at least one anode solvent 7 is an ionic liquid that is selected from the group consisting of 1-ethyl-3-methylimidazolium acetate [EMIM][Ac], 1-butyl-3-methylimidazolium acetate [BMIM][Ac], 1-butyl-3-methylimidazolium bis(trifluoromethylsulfonyl)imide [BMIM][Tf₃N], and a solvent mixture containing 50% 1-ethyl-3-methylimidazolium acetate [EMIM][Ac] and 50% 1-butyl-3-methylimidazolium bis(trifluoromethylsulfonyl) imide [BMIM][Tf3N]. The members of the aforementioned anode solvent 7 group were selected based on the existing knowledge regarding imidazolium-based ionic liquids. The imidazolium-based ionic liquids contain cations with short chain hydrocarbon tails that allow for a lower viscosity. It has been seen experimentally that the lower viscosity of an ionic liquid due to short chain hydrocarbon tails can improve the ionic conductivity of said ionic liquid. In the preferred embodiment of the present invention, the at least one anode solvent 7 selected from the group is 1-ethyl-3-methylimidazolium acetate [EMIM][Ac]. 1-ethyl-3-methylimidazolium acetate [EMIM][Ac] is an ionic liquid that comprises the 1-ethyl-3-methylimidazolium cation, a heterocyclic aromatic cation with a short hydrocarbon tail, and the acetate anion, an organic anion. The 1-ethyl-3-methylimidazolium acetate was selected as the anode solvent 7 based on experimentation results which demonstrated favorable performance in the Sodium Sulfur battery that utilized 1-ethyl-3-methylimidazolium as the anode solvent 7.

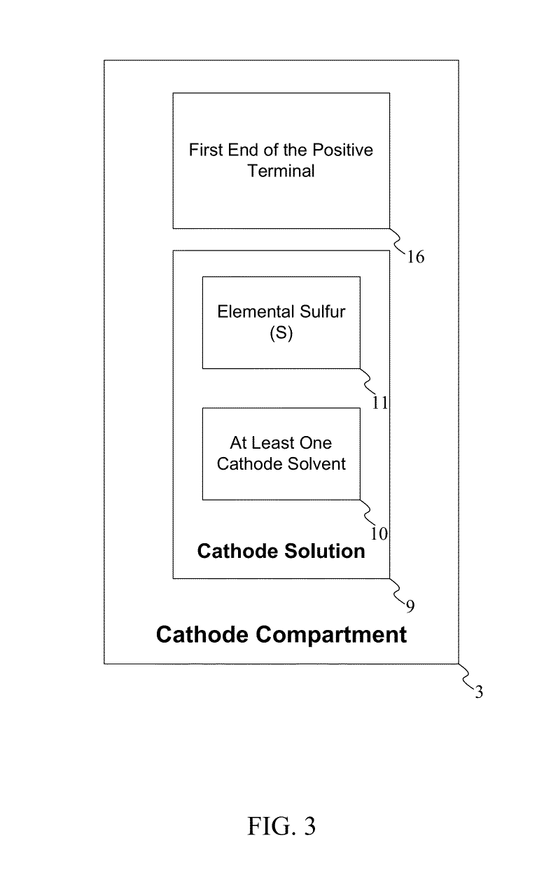

Referencing FIG. 3, the cathode solution 8 is an electrolyte that functions as the positive electrode for the present invention. The cathode solution 8 is found positioned within the cathode compartment 3 of the housing 1. The cathode solution 8 is separated from the anode solution 6 by the sodium ion conductive electrolyte membrane 5. The cathode solution 8 is in electrical contact with the positive terminal 15 due to the positioning of the positive terminal 15 within the cathode compartment 3. The positive terminal 15 is able to maintain an electrical contact with the cathode solution 8 due to it being at least partially immersed in the cathode solution 8. In the current embodiment of the present invention, the cathode solution 8 comprises at least one cathode solvent 10 and elemental sulfur 11. The at least one cathode solvent 10 is provided as a polar solvent that has certain solubility to elemental sulfur 11 at temperatures below elemental sulfur 11s melting point, wherein elemental's sulfur's melting point is 115.2° C. The elemental sulfur 11 is provided as the cathode for the sodium sulfur battery. the elemental sulfur 11 is suspended within the at least one cathode solvent 10 due to the at least one cathode solvent 10 being heavier than the elemental sulfur 11, wherein elemental sulfur 11 has a specific gravity of 2.070 g/cm³ at 25° C. The at least one cathode solvent 10 is provided as a means of allowing dissolved sulfur ions and sulfur allotropes to interact with the surface of the sodium ion conductive electrolyte membrane 5. During the discharge cycle of the sodium sulfur battery, sodium ions traverse the sodium ion conductive electrolyte membrane 5 and oxidize dissolved sulfur and dissolved allotropes of sulfur (polysulfides). The resulting electron traverses the at least one cathode solvent 10 to the first end of the positive terminal 16. During the charging cycle of the sodium sulfur battery, electrons received from the positive terminal 15 traverse the at least one cathode solvent 10 and reduce the sodium sulfide and sodium polysulfide forming sodium ions and dissolved elemental sulfur 11 and dissolved polysulfides. In the current embodiment of the present invention, the elemental sulfur 11 is provided with a mass concentration up to 1800 g/L to the at least one cathode solvent 10. The mass concentration of the cathode solution 8 was determined based on experimentation results which demonstrated favorable performance in the sodium sulfur battery.

TABLE 3
Cathode Solvents

| | Molecular Weight | CAS Registry | |
|---|---|---|---|
| Solvent | (Mw) | Number | Density (g/cm) |
| Tetra(ethylene glycol) | 222.28 | 143-24-8 | 1.009 |
| dimethyl ether (TG) | | | |
| N,N-Dimethylaniline | 121.18 | 121-69-7 | 0.956 |
| (DMA) | | | |
| Tetrahydrofuran (THF) | 72.11 | 109-99-9 | 0.890 |

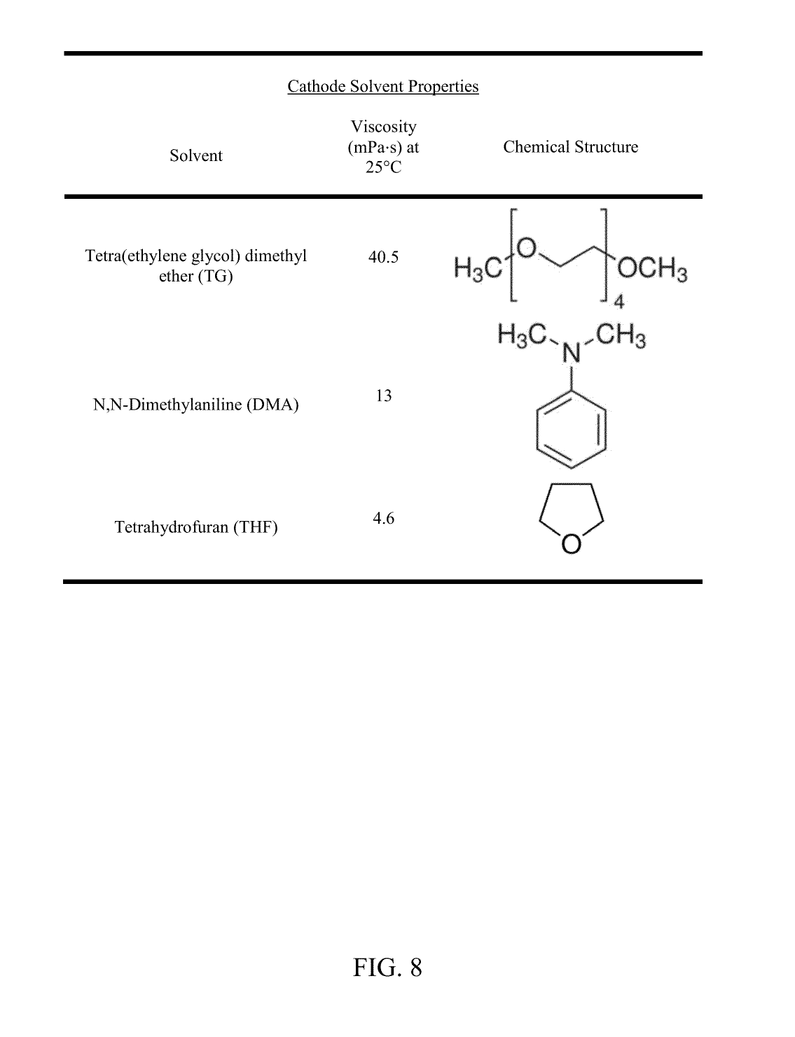

Referencing FIG. 8, in the current embodiment of the present invention, the at least one cathode solvent 10 is a polar solved that is selected form the group consisting of Tetra(ethylene glycol) dimethyl ether (TG), N,N-Dimethylaniline (DMA), and Tetrahydrofuran (THF). The members of the aforementioned cathode solvent 10 group were selected based on their specific gravity, solubility to elemental sulfur 11, sodium ions, sodium polysulfides, and ion conductivity for sodium ions. In the preferred embodiment of the present invention, the at least one cathode solvent 10 selected from the group is Tetra (ethylene glycol) dimethyl ether (TG). Tetra (ethylene glycol) dimethyl ether (TG) is a polar aprotic solvent that has excellent chemical and thermal stability. Tetra (ethylene glycol) dimethyl ether has traditionally been used in the production of lithium-ion batteries. Tetra (ethylene glycol) dimethyl ether was selected as the anode solvent 7 based on experimentation results which demonstrated favorable performance in the Sodium Sulfur battery that utilized Tetra (ethylene glycol) dimethyl ether as the cathode solvent 10.

TABLE 4
Battery Composition Performance Results

| | | | | Charge |
|---|---|---|---|---|
| Cathode | Anode | Open Voltage | Cycling | Discharge |
| Solution | Solution | (V_{oc}) at R.T. | Voltage (V_{cyc}) | Cycles |
| (TG) | [EMIM][Ac] | 0.6 V | 2.15 V at 25° C. | 522 cycles |
| | | | 2.35 V at 60° C. | at 60° C. |
| (DMA) | [EMIM][Ac] | 0.55 V | | 132 cycles |
| | | | | at 50° C. |
| (THF) | [EMIM][Ac] | 0.86 V | 2.08 V at 60° C. | 590 cycles |
| | | | | at 60° C. |
| (TG) | [BMIM][Ac] | 0.6 V | 2.00 V at 60° C. | 74 cycles |
| | | | | at 60° C. |
| (DMA) | [BMIM][Ac] | 0.7 V | 2.00 V at 60° C. | 361 cycles |
| | | | | at 60° C. |
| (THF) | [BMIM][Ac] | 1.2 V | 2.17 V at 60° C. | 256 cycles |
| | | | | at 60° C. |
| (TG) | [BMIM][Tf₃N] | 0.45 V | 2.01 V at 60° C. | 464 cycles |
| | | | | at 60° C. |
| (DMA) | [BMIM][Tf₃N] | 1.03 V | 2.23 V at 70° C. | |
| (TG) | 50% [EMIM][Ac] | 0.96 V | 2.21 V at 70° C. | 162 cycles |
| | 50% [BMIM][Tf₃N] | | | at 70° C. |
| (DMA) | 50% [EMIM][Ac] | 0.78 V | 2.01 V at 70° C. | 363 cycles |
| | 50% [BMIM][Tf₃N] | | | at 70° C. |
| (THF) | 50% [EMIN][Ac] | 0.65 V | 2.15 V at 70° C. | 456 cycles |
| | 50% [BMIN][Tf₃N] | | | at 70° C. |

In the current embodiment of the present invention, the housing 1 is constructed of light weight plastic materials due to the reduced temperature requirements associated with operating the sodium sulfur secondary battery. The current embodiment of the present invention can utilizes a plurality of light weight plastic materials that include but are not limited to polypropylene (PP), poly-vinyl-chloride (PVC), and Polytetrafluoroethylene (PTFE), as well as other non-metal materials. In the current embodiment of the present invention, the housing 1 is constructed of poly-vinyl-chloride (PVC). PVC is elected as the material of choice for the housing 1 due to test results that showed favorable interactions between a housing 1 constructed of PVC and the preferred embodiment of the present invention utilizing 1-ethyl-3-methylimidazolium acetate [EMIM][Ac] as the at least one anode solvent 7 and Tetra(ethylene glycol) dimethylether (TG) as the at least one cathode solvent 10. it should be noted that due to the light weight plastic construction of the housing 1 and the plurality of attachment means provided for the separator mount 4, the housing 1 can be provided in a plurality of configurations that include horizontal and vertical arrangements, as well as geometric shapes such as cylinder (column), cubic block, sphere, and discs.

In the current embodiment of the present invention, the housing 1 functioning primarily as an enclosure for the anode compartment 2 and the cathode compartment 3, and as an attachment point for the sodium ion conductive electrolyte membrane 5 it. although the separation between the anode compartment 2 and the cathode compartment 3 is described as being the result of the positioning of the sodium ion conductive electrolyte membrane 5, the anode compartment 2, and the cathode compartment 3 can be provided as existing chambers constructed specifically for containing the anode solution 6 and the cathode solution 8 respectively. In the aforementioned interpretation, the housing 1 would comprise two distinct pre-constructed chambers that would correspond to the anode compartment 2 and the cathode compartment 3, wherein both the anode compartment 2 and the cathode compartment 3 would comprise a separator mount 4. Upon attaching the sodium ion conductive electrolyte membrane 5 to the separator mount 4 of the anode compartment 2 and the separator mount 4 of the cathode compartment 3, the two distinct pre-constructed chambers would contain the all existing component arrangements as seen in the current embodiment of the present invention.

In the current embodiment of the present invention, the sodium ion conductive electrolyte membrane 5 is a Sodium Titanate Nano-membrane. The sodium titanate nano-membrane is capable of selectively transporting sodium ions between the anode solution 6 and the cathode solution 8. The sodium titanate nano-membrane is a non-electrically conductive ceramic nano-membrane that is substantially impermeable to water. The sodium titanate nano-membrane is constructed using a solution synthesis technique that forms long TiO₂-nanowire membranes. The solution synthesis of long TiO₂-nanowire membranes is accomplished through a new hydrothermal synthesis technique that allows the TiO₂-nanowires to be directly casted into thermalstable, robust, and multifunctional free standing membranes (FSM). Through the solution synthesis process, FSMs can be formed into two dimension (2D) paper like sheets as well as three dimensional objects in nearly any macroscopic size and shape. The solution synthesis of long TiO₂-nanowires typically occurs over a period of 1-7 days in an oven with temperatures above 160° C. Although the synthesis of TiO₂-nanowires can occur within a few days time and at lower temperatures, reduction in the processing time results in the formation of shorter TiO₂-nanotubes which ultimately lead to an FSM with a compromised/brittle construction. In a typical synthesis, 0.30 g of TiO₂ powder is introduced into 40 mL of 10M alkali solution in a 150 mL Teflon-lined autoclave container. The mixture undergoes a hydrothermal reaction in an oven over the course of 7 days maintaining a temperature exceeding 160° C. after the hydrothermal reaction is terminated, a white pulp-like product of the long nano-wires was collected, washed with distilled water or dilute acid, then cast on the macroscopic templates and/or molds made of either ash-less filter-paper or polyethylene film, and then dried at room temperature (RT). This casting-drying process is repeated several times at room temperature, and is then followed thereafter by a heating the cast in an oven over the course of 1-20 hours with temperatures ranging between 40-100° C. The 2D membrane paper can be formed from drying of the pulp-like slurry of the long nano-fibers on a plastic plate. In likewise fabrication, the 3D device, the templates and molds of polyethylene can be easily detached by hand, while those made of the ash-less filter paper can be readily removed by either an open flame or a heating in a furnace at ˜500° C. in air.

TABLE 5
Summary of Experimental Membrane Ionic Conductivity

| Sodium Titanate Nano-Membrane | Ion Conductivity (S/cm) at 25° C. |
|---|---|
| #17 | 1.2 × 10⁻⁷ |
| #25 | 1.8 × 10⁻⁷ |
| #26 | 3.0 × 10⁻⁶ |
| #27 | 0.45 × 10⁻⁵ |
| #28 | 0.34 × 10⁻⁵ |
| #35 | 0.26 × 10⁻⁵ |

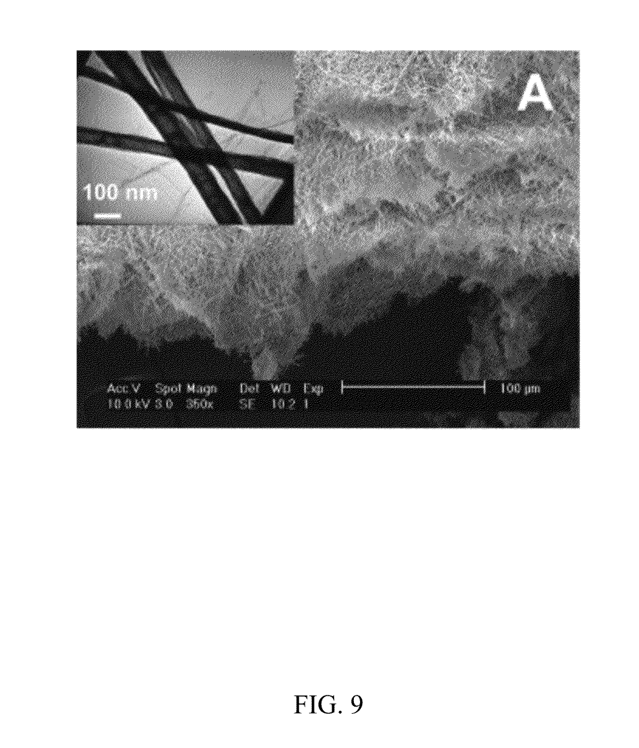

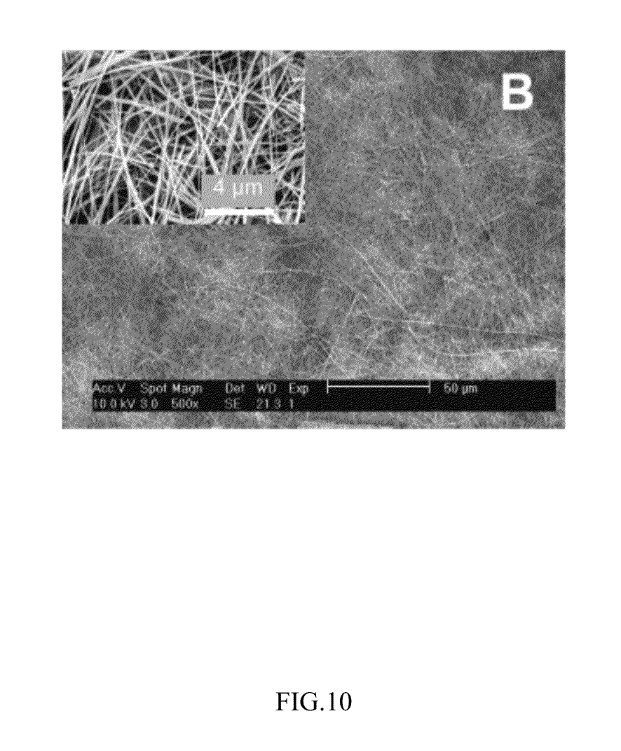

Referencing FIG. 9 and FIG. 10, in the current embodiment of the present invention the sodium titanate nano-membrane is selected from a group of several variably constructed sodium titanate nano-membranes. Using variations of the aforementioned process, long TiO₂-nanowires were fused and hydrothermally casted into a several sodium titanate nano-membranes. Each nano membrane was created in a reproducible manner and was experimentally tested to determine an optimal membrane. In the preferred embodiment of the present invention, the optimal membrane was determined based on experimentation results which demonstrated favorable performance in the Sodium Sulfur battery assembly, the selected sodium titanate nano-membrane is a 40 nanometer thick membrane with an ionic conductivity to the sodium ions of 0.8 mS/cm at 25° C.

In the current embodiment of the present invention, the sodium sulfur battery is provided in a configuration that enables it to function as a galvanic cell and an electrolytic cell, wherein the differentiation between the galvanic cell and the electrolytic cell is dependent on the particular operating cycle. The particular operating cycles for the sodium sulfur battery are the charge cycle and the discharge cycle. During the charge cycle, the sodium sulfur battery functions as an electrolytic cell by converting electrical energy received from an external circuit into chemical energy. During the discharge cycle, the sodium sulfur battery functions as a galvanic cell, wherein an external circuit draws energy from the sodium sulfur battery converting chemical energy into electrical.

### Charge Cycle:

Oxidation reaction taking place the cathode compartment.
Na₂Sₓ→xS+2Na⁺+e⁻

Reduction reaction taking place in the anode compartment.
Na⁺+e⁻→Na

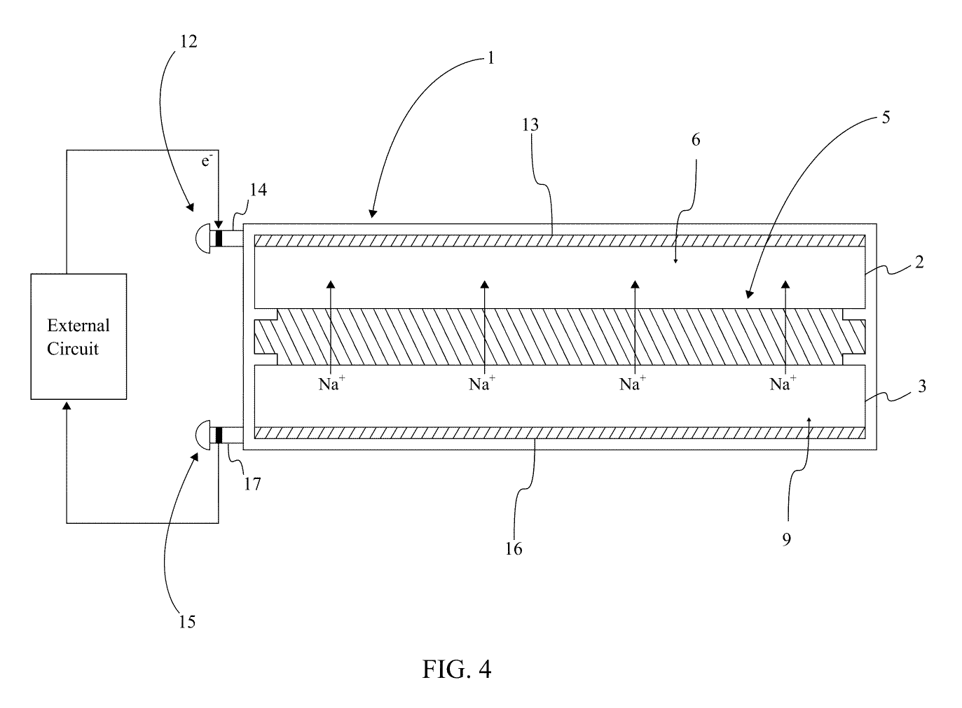

Referencing FIG. 4, in the current embodiment of the present invention, the charging cycle of the sodium sulfur battery functions as an electrolytic cell converting electrical energy into chemical energy. The charging cycle is initiated by the attachment of the second end of the positive terminal 17 and the second end of the negative terminal 14 to corresponding contacts of an external circuit. In the charging cycle, the external circuit provides an electrical current to the sodium sulfur battery, conducting electrons through the engagement of the negative terminal 12 with the corresponding contact through the first end of the negative terminal 13 and the anode solution 6. Prior to the attachment of the corresponding contacts the sodium sulfur battery has an open circuit voltage (V_{oc}) of 0.6 Volts. The conduction of the electrons to the anode solution 6 causes the sodium ions to traverse the sodium ion conductive electrolyte membrane 5 to the anode solution 6, upon which the sodium ions are reduced to their dissolved metallic form. The movement of the sodium ion from cathode solution 8 to the anode solution 6 raising the electrode potential across the sodium ion conductive membrane producing a Cycling voltage (V_{cyc}) of 2.15 volts at 25° C.

### Battery Discharging:

Oxidation reaction taking place in the anode compartment.

Na→Na⁺+e⁻

Reduction reaction taking place in the cathode compartment.

2Na⁺+xS+e⁻→Na₂Sₓ

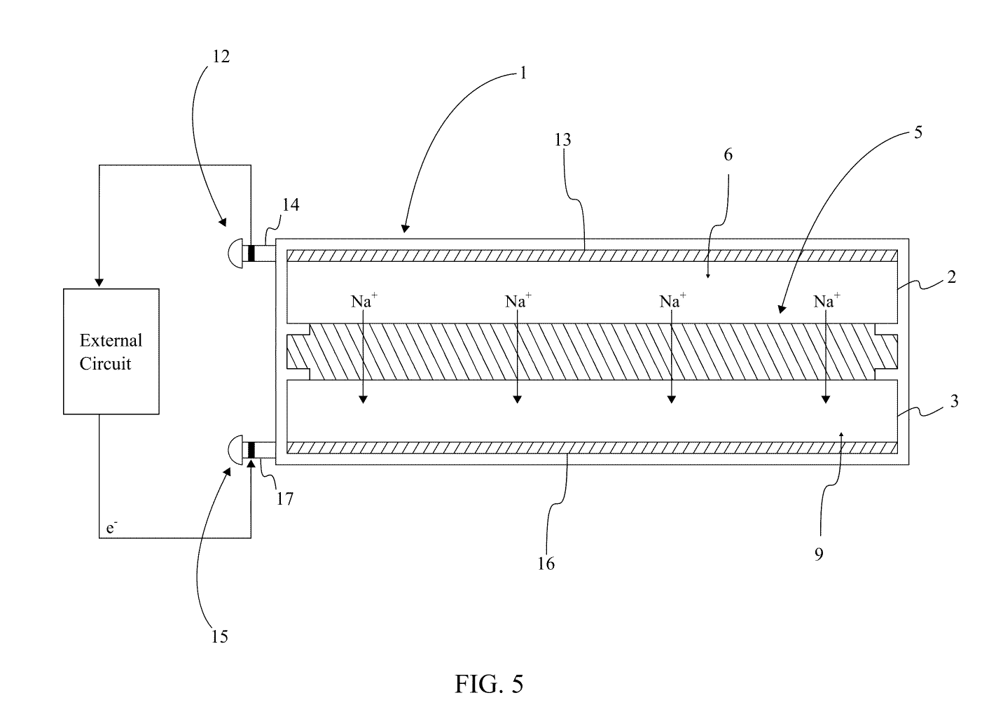

Referencing FIG. 5, in the current embodiment of the present invention, the discharge cycle of the sodium sulfur battery functions as a galvanic cell converting chemical energy into electrical energy. The discharge cycle is initiated upon the attachment of second end of the positive terminal 17 and the second end of the negative terminal 14 to corresponding contacts of an external circuit. In the discharge cycle, the external circuit draws an electrical current from the sodium sulfur battery, drawing electrons through the engagement of the negative terminal 12 with the corresponding contact through the first end of the negative terminal 13 and the anode solution 6. Prior to the attachment of the corresponding terminals the electrode potential of the sodium sulfur battery is calculated to be around 2.15 Volts. The conduction of electrons form the anode solution 6 to the external circuit causes the oxidation of the metallic sodium 8 forming sodium ions that are able to traverse the sodium ion conductive membrane into the cathode solution 8. Through the movement of the sodium ion from the anode compartment 2 to the cathode compartment 3, the electrode potential of the across the sodium ion conductive membrane falls to the to its open circuit voltage of 0.6 volts at 25° C.

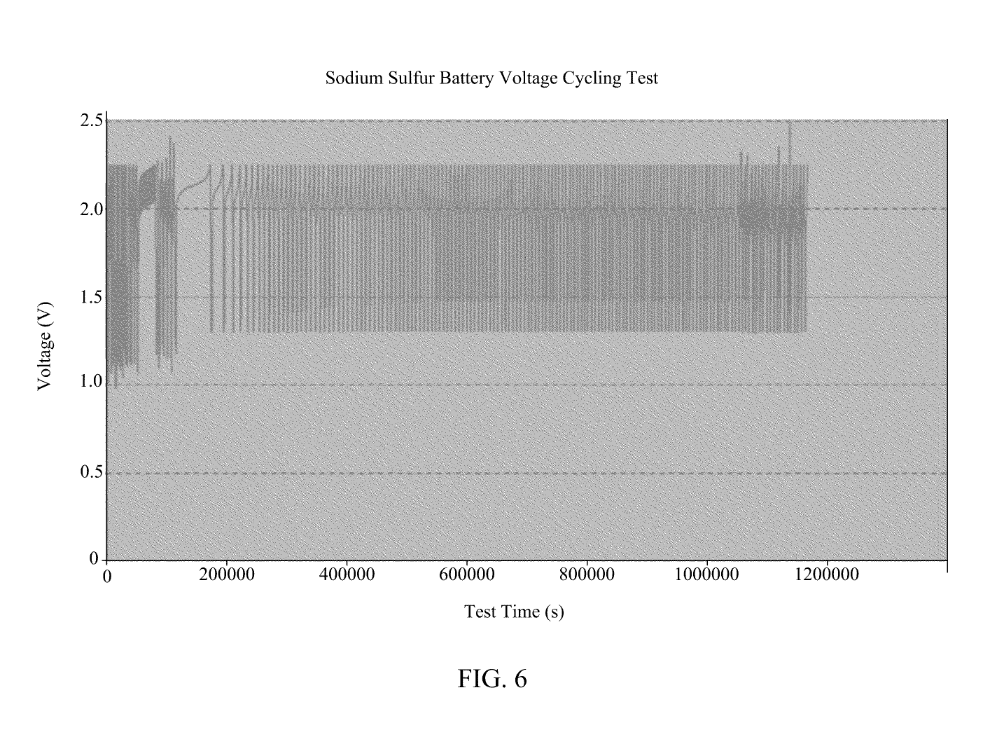

Referencing FIG. 6, in the preferred embodiment of the present invention, the sodium sulfur battery was experimentally determined to have a V_{oc} of 0.6V prior to the attachment of the corresponding connectors at 25° C. The present invention was able to be cycled for 169 times at 25° C. with a consistent cycling voltage of 2.15V. The preferred embodiment was additionally tested at higher temperatures producing higher sodium ion conductivity values. The sodium sulfur battery was cycled 522 at 60° C. before failing, producing a consistent cycling voltage of 2.35V.

In the current embodiment of the present invention, the anode solvent 7 is an ionic liquid. Although the current embodiment of the present invention utilizes an ionic liquid, additional embodiments of the present invention may use any non-aqueous negative electrolyte capable of transporting sodium ions is, that is in a liquid state at the sodium sulfur battery operating temperature range. Additionally, the non-aqueous negative electrolyte must be chemically compatible with the materials of the negative terminal 12, the anode compartment 2, and the sodium ion conductive electrolyte membrane 5. Potential non-aqueous negative electrolytes can be organic electrolytes as well as ionic liquids. Possible non-aqueous negative electrolyte that can be utilized by the present invention can include but are not limited to tri ethyl sulfonium, Imidazoliums, such as 1-ethyl-3-methylimidazolium chloride; Pyridiniums such as N-butylpyridinium chloride; Pyrrolidiniums such as 1-butyl-1-methylpyrrolidinium chloride; and Ammoniums such as methyl (trioctyl) ammonium trifluoroacetate. Among these, quaternary ammonium-based ionic liquids and methyl ester groups containing the cations 1,3-dimethylimidazolium trifluoromethylsulfonate are especially suitable for the present invention. Although, the Ionic liquids based on 2-substituted imidazolium, 8-tetraalkylammonium, pyrrolidinium, and piperidinium can be utilized as a non-aqueous negative electrolyte, their cations were found to exhibit better cathodic stability toward lithium based batteries.

In the current embodiment of the present invention, the cathode solvent 10 is selected from a short list of polar solvents. Although the current embodiment of the present invention utilizes only suggests three polar solvents as the cathode solvent 10, additional embodiments may use any suitable material that is in a liquid state at the sodium sulfur battery operating temperature range and is capable of conducting sodium ions to and from the sodium ion conductive electrolyte membrane 5. Additionally, the suitable material must be chemically compatible with the materials of the positive terminal 15, the cathode compartment 3, sulfur ions, and the sodium ion conductive electrolyte membrane 5. Possible solutions can include but are not limited to sodium hydroxide, water, glycerol, borax, sodium tetraborate decahydrate, sodium metaborate tetrahydrate, boric acid, sodium borohydride, sodium borate, sodium phosphate, sodium hydrogen phosphate, sodium glycerol, sodium carbonate, ethylene, propylene, one or more ionic liquids, and any suitable combination thereof. Preferably the suitable material is another polar solvent is that remains in the liquid phase throughout the operating temperatures of the sodium sulfur battery. The additional polar solvents that could potentially be incorporated into the additional embodiment of the present invention can include but are not limited to N-methyl formamide (NMF), formamide, dimethylformamide, tetraglyme, and diglyme, dimethylether. Most of these solvents have specific gravity in the range of (0.9 g/cubic centimeter to 1.1 g/cubic centimeter which is beneficial for suspending dissolved elemental sulfur 11 and sodium poly sulfides. Additionally, the cathode solvent 10 can be an ionic liquid such as Ethanolammonium nitrate, and imidazolium halogenoaluminate salts and others. Other embodiments may use acetamide, methylacetamide, or dimethylacetamide as the cathode solvent 10.

Although the invention has been explained in relation to its preferred embodiment, it is to be understood that many other possible modifications and variations can be made without departing from the spirit and scope of the invention as hereinafter claimed.

What is claimed is:

1. A sodium sulfur secondary battery which operates at ambient temperatures comprises:
a housing;
a sodium ion conductive electrolyte membrane;
an anode solution;
a cathode solution;
a negative terminal, wherein the negative terminal is constructed of a highly electrically conductive material inert to the anode solution;
a positive terminal, wherein the positive terminal is constructed of a tough corrosion resistant material;
the housing comprises an anode compartment, a cathode compartment, and a separator mount;
the negative terminal and the positive terminal each comprises a first end and a second end;
the anode solution comprises at least one anode solvent and metallic sodium;
the at least one anode solvent having solubility to the metallic sodium enabling the formation of sodium ions at temperatures of less than 100° C.;
the cathode solution comprises at least one cathode solvent and elemental sulfur;
the at least one cathode solvent having solubility to the elemental sulfur enabling the formation of sulfur ions at temperatures less than 100° C.;
the sodium ion conductive electrolyte membrane, the anode solution, and the cathode solution being sealed within the housing;
the sodium ion conductive electrolyte membrane being secured to the housing by way of the separator mount;
the anode solution being positioned within the anode compartment;
the cathode solution being positioned within the cathode compartment;
the sodium ion conductive electrolyte membrane being positioned between the anode compartment and the cathode compartment;
the anode solution and the cathode solution being selectively separated by way of the sodium ion conductive electrolyte membrane, wherein the sodium ion conductive electrolyte membrane selectively transports sodium ions between the anode solution and the cathode solution at temperatures below 75° C.;
the anode compartment being traversed into by first end of the negative terminal;
the first end of the negative terminal being in electrical contact with the anode solution by being at least partially immersed in the anode solution;
the second end of the negative terminal being peripherally positioned to the housing;
the cathode compartment being traversed into by first end of the positive terminal;
the first end of the positive terminal is in electrical contact with the cathode solution by being at least partially immersed in the cathode solution; and
the second end of the positive terminal being peripherally positioned to the housing.

2. The sodium-sulfur secondary battery which operates at ambient temperatures as claimed in claim 1, wherein the sodium ion conductive electrolyte membrane is a Sodium Titanate Nano-membrane capable of selectively transporting sodium ions between the anode solution and the cathode solution with an ionic conductivity around 0.8 milli-Siemens/centimeter (mS/cm) at 25° C.

3. The sodium-sulfur secondary battery which operates at ambient temperatures as claimed in claim 1, wherein the metallic sodium is provided with a mass concentration up to 900 g/L to the at least one anode solvent.

4. The sodium-sulfur secondary battery which operates at ambient temperatures as claimed in claim 1, wherein the at least one anode solvent is selected from the group consisting of 1-ethyl-3-methylimidazolium acetate [EMIM][Ac], 1-butyl-3-methylimidazolium acetate [BMIM][Ac], 1-butyl-3-methylimidazolium bis(trifluoromethylsulfonyl)imide [BMIM][Tf₃N], and a solvent mixture containing 50% 1-ethyl-3-methylimidazolium acetate [EMIM][Ac] and 50% 1-butyl-3-methylimidazolium bis(trifluoromethylsulfonyl)imide [BMIM][Tf₃N].

5. The sodium-sulfur secondary battery which operates at ambient temperatures as claimed in claim 2, wherein the at least one anode solvent is 1-ethyl-3-methylimidazolium acetate [EMIM][Ac].

6. The sodium-sulfur secondary battery which operates at ambient temperatures as claimed in claim 1, wherein the elemental sulfur is provided with a mass concentration up to 1800 g/L to the at least one cathode solvent.

7. The sodium-sulfur secondary battery which operates at ambient temperatures as claimed in claim 1, wherein the at least one cathode solvent is selected from the group consisting of Tetra(ethylene glycol) dimethylether (TG), N,N-Dimethylaniline (DMA), and Tetrahydrofuran (THF).

8. The sodium-sulfur secondary battery which operates at ambient temperature as claimed in claim 7, wherein the at least one cathode solvent is Tetra(ethylene glycol) dimethylether (TG).

9. The sodium-sulfur secondary battery which operates at ambient temperature as claimed in claim 1, wherein the highly electrically conductive material of the negative terminal is copper.

10. The sodium-sulfur secondary battery which operates at ambient temperature as claimed in claim 1, wherein the tough corrosion resistant material of the positive terminal is graphite.

11. A sodium sulfur secondary battery which operates at ambient temperatures comprises:
a housing;
a Sodium Titanate Nano-membrane capable of selectively transporting sodium ions between the anode solution and the cathode solution with an ionic conductivity around 0.8 milli-Siemens/centimeter (mS/cm) at 25° C.;
an anode solution;
a cathode solution;
a negative terminal, wherein the negative terminal is constructed of copper;
a positive terminal, wherein the positive terminal is constructed of graphite;
the housing comprises an anode compartment, a cathode compartment, and a separator mount;
the negative terminal and the positive terminal each comprises a first end and a second end;
the anode solution comprises at least one anode solvent and metallic sodium;
the at least one anode solvent having solubility to the metallic sodium enabling the formation of sodium ions at temperatures of less than 100° C.;
the metallic sodium being provided with a mass concentration up to 900 g/L to the at least one anode solvent;
the cathode solution comprises at least one cathode solvent and elemental sulfur;
the at least one cathode solvent having solubility to the elemental sulfur enabling the formation of sulfur ions at temperatures less than 100° C.;
the elemental sulfur being provided with a mass concentration up to 1800 g/L to the at least one cathode solvent;
the sodium ion conductive electrolyte membrane, the anode solution, and the cathode solution being sealed within the housing;
the sodium ion conductive electrolyte membrane being secured to the housing by way of the separator mount;
the anode solution being positioned within the anode compartment;
the cathode solution being positioned within the cathode compartment;
the sodium ion conductive electrolyte membrane being positioned between the anode compartment and the cathode compartment;
the anode solution and the cathode solution being selectively separated by way of the sodium ion conductive electrolyte membrane, wherein the sodium ion conductive electrolyte membrane selectively transports sodium ions between the anode solution and the cathode solution at temperatures below 75° C.;
the anode compartment being traversed into by first end of the negative terminal;
the first end of the negative terminal being in electrical contact with the anode solution by being at least partially immersed in the anode solution;
the second end of the negative terminal being peripherally positioned to the housing;
the cathode compartment being traversed into by first end of the positive terminal;
the first end of the positive terminal is in electrical contact with the cathode solution by being at least partially immersed in the cathode solution; and
the second end of the positive terminal being peripherally positioned to the housing.

12. The sodium-sulfur secondary battery which operates at ambient temperatures as claimed in claim 11, wherein the at least one anode solvent is selected from the group consisting of 1-ethyl-3-methylimidazolium acetate [EMIM][Ac], 1-butyl-3-methylimidazolium acetate [BMIM][Ac], 1-butyl-3-methylimidazolium bis(trifluoromethylsulfonyl)imide [BMIM][Tf₃N], and a solvent mixture containing 50% 1-ethyl-3-methylimidazolium acetate [EMIM][Ac] and 50% 1-butyl-3-methylimidazolium bis(trifluoromethylsulfonyl)imide [BMIM][Tf₃N].

13. The sodium-sulfur secondary battery which operates at ambient temperatures as claimed in claim 12, wherein the at least one anode solvent is 1-ethyl-3-methylimidazolium acetate [EMIM][Ac].

14. The sodium-sulfur secondary battery which operates at ambient temperatures as claimed in claim 11, wherein the at least one cathode solvent is selected from the group consisting of Tetra(ethylene glycol) dimethylether (TG), N,N-Dimethylaniline (DMA), and Tetrahydrofuran (THF).

15. The sodium-sulfur secondary battery which operates at ambient temperature as claimed in claim 16, wherein the at least one cathode solvent is Tetra(ethylene glycol) dimethylether (TG).

16. A sodium sulfur secondary battery which operates at ambient temperatures comprises:
a housing;
a Sodium Titanate Nano-membrane capable of selectively transporting sodium ions between the anode solution and the cathode solution with an ionic conductivity around 0.8 milli-Siemens/centimeter (mS/cm) at 25° C.;
an anode solution;
a cathode solution;
a negative terminal, wherein the negative terminal is constructed of copper;
a positive terminal, wherein the positive terminal is constructed of graphite;
the housing comprises an anode compartment, a cathode compartment, and a separator mount;
the negative terminal and the positive terminal each comprises a first end and a second end;
the anode solution comprises 1-ethyl-3-methylimidazolium acetate [EMIM][Ac] and metallic sodium;
the 1-ethyl-3-methylimidazolium acetate [EMIM][Ac] having solubility to the metallic sodium enabling the formation of sodium ions at temperatures of less than 100° C.;
the metallic sodium being provided with a mass concentration up to 900 g/L to the 1-ethyl-3-methylimidazolium acetate [EMIM][Ac];
the cathode solution comprises Tetra(ethylene glycol) dimethylether (TG) and elemental sulfur;
the Tetra(ethylene glycol) dimethylether (TG) having solubility to the elemental sulfur enabling the formation of sulfur ions at temperatures less than 100° C.;
the elemental sulfur being provided with a mass concentration up to 1800 g/L to the Tetra(ethylene glycol) dimethylether (TG);
the sodium ion conductive electrolyte membrane, the anode solution, and the cathode solution being sealed within the housing;
the sodium ion conductive electrolyte membrane being secured to the housing by way of the separator mount;
the anode solution being positioned within the anode compartment;
the cathode solution being positioned within the cathode compartment;
the sodium ion conductive electrolyte membrane being positioned between the anode compartment and the cathode compartment;
the anode solution and the cathode solution being selectively separated by way of the sodium ion conductive electrolyte membrane, wherein the sodium ion conductive electrolyte membrane selectively transports sodium ions between the anode solution and the cathode solution at temperatures below 75° C.;
the anode compartment being traversed into by first end of the negative terminal;
the first end of the negative terminal being in electrical contact with the anode solution by being at least partially immersed in the anode solution;
the second end of the negative terminal being peripherally positioned to the housing;
the cathode compartment being traversed into by first end of the positive terminal;
the first end of the positive terminal is in electrical contact with the cathode solution by being at least partially immersed in the cathode solution; and
the second end of the positive terminal being peripherally positioned to the housing.
